(19) United States
(12) Patent Application Publication
(10) Pub. No.: US 2025/0192372 A1
(43) Pub. Date: Jun. 12, 2025

(54) BIPOLAR ELECTRODE AND BIPOLAR BATTERY

(71) Applicant: TOYOTA JIDOSHA KABUSHIKI KAISHA, Aichi-ken (JP)

(72) Inventor: Naoki OSADA, Toyota-shi (JP)

(21) Appl. No.: 18/961,445

(22) Filed: Nov. 27, 2024

(30) Foreign Application Priority Data
Dec. 7, 2023 (JP) 2023-207104

(51) Int. Cl. H01M 50/494; H01M 4/02; H01M 4/36; H01M 4/38; H01M 50/411; H01M 50/446; H01M 50/497

(52) U.S. Cl. CPC H01M 50/494; H01M 4/364; H01M 4/386; H01M 50/411; H01M 50/446; H01M 50/497; H01M 2004/021; H01M 2004/029

(57) ABSTRACT

A bipolar electrode includes a cathode substrate that configures a current collector, a cathode composite layer formed on the cathode substrate, an anode substrate that configures a current collector, an anode composite layer that is formed on the anode substrate and that is divided into plural regions by a groove between adjacent regions of the plurality of regions, with the anode substrate as a bottom portion of the groove, and an elastic layer having elastic properties that is formed between the anode substrate and the anode composite layer. The electrode includes the cathode composite layer, the cathode substrate, the anode substrate, the elastic layer, and the anode composite layer stacked in this sequence.

### CROSS-REFERENCE TO RELATED APPLICATION

This application is based on and claims priority under 35 USC 119 from Japanese Patent Application No. 2023-207104 filed on Dec. 7, 2023, the disclosure of which is incorporated by reference herein.

### BACKGROUND

### Technical Field

The present disclosure relates to a bipolar electrode and to a bipolar battery.

### Related Art

For example, Japanese Patent Application Laid-Open (JP-A) No. 2019-0192338 discloses technology for an all-solid-state battery in which a surface area of a part of an electrode surface that participates in an electrode reaction of an electrode layer is appropriately adjusted by forming slit-shaped grooves in the electrode surface, thereby enabling expansion of the electrode layer to be suppressed as a result of the slit-shaped grooves acting as a portion where expansion and contraction of the electrode layer is absorbed.

The electrode of a bipolar battery includes composite layers that are disposed on each face of a current collector and have different expansion and contraction behaviors during charging and discharging, and so warping possibly develops in the electrode during charging and discharging due to these composite layers.

Note that in the all-solid-state battery disclosed in JP-A No. 2019-0192338, all configuration materials including the composite layers are solidified, and so there is a significantly lower possibility of warping developing in the electrode compared to a liquid battery employing an electrolytic solution.

The present disclosure provides a bipolar electrode and a bipolar battery that are each capable of suppressing warping developing during charging and discharging.

### SUMMARY

A bipolar electrode of a first aspect includes a cathode substrate that configures a current collector, a cathode composite layer formed on the cathode substrate, an anode substrate that configures a current collector, an anode composite layer that is formed on the anode substrate and that is divided into plural regions by a groove between adjacent regions of the plurality of regions, with the anode substrate as a bottom portion of the groove, and an elastic layer having elastic properties that is formed between the anode substrate and the anode composite layer. The cathode composite layer, the cathode substrate, the anode substrate, the elastic layer, and the anode composite layer are stacked in this sequence.

A bipolar electrode of a second aspect is the first aspect, wherein the elastic layer has a tensile-shear adhesive strength of from 15 MPa to 40 MPa, a peel adhesive strength of from 3 N to 10 N, a modulus of elasticity of from 700 MPa to 1200 MPa, a breaking strength of from 15 MPa to 25 MPa, and an elongation percentage at breaking of from 5% to 30%.

A bipolar electrode of a third aspect is the first aspect or the second aspect, wherein the elastic layer has an electron conductivity of 1 mS/cm.

A bipolar electrode of a fourth aspect is any one of the first aspect to the third aspect, wherein the elastic layer contains a conductive auxiliary agent and a polymer material.

A bipolar electrode of a fifth aspect is any one of the first aspect to the fourth aspect, wherein a thickness of the elastic layer is 10 μm or less.

A bipolar electrode of a sixth aspect is any one of the first aspect to the fifth aspect, wherein the anode composite layer has a rectangular shape as viewed from a stacking direction, and plural of grooves are formed so as to respectively extend at the anode composite layer along directions substantially parallel to a short edge side and a long edge side of the anode composite layer as viewed from the stacking direction.

A bipolar electrode of a seventh aspect is any one of the first aspect to the sixth aspect, wherein the anode composite layer includes at least an anodic active material, and the anodic active material contains silicon (Si) at a content of 10% or less.

The bipolar electrode of an eighth aspect is any one of the first aspect to the seventh aspect, wherein a groove width of the groove is from 50 μm to 5 mm.

The bipolar electrode of a ninth aspect is any one of the first aspect to the eighth aspect, wherein a spacing between adjacent grooves is from 1 mm to 100 mm.

A bipolar electrode of a tenth aspect is any one of the first aspect to the ninth aspect, wherein a proportion of a groove width of the groove with respect to a spacing between adjacent grooves is 0.05.

A bipolar electrode of an eleventh aspect is any one of the first aspect to the tenth aspect, wherein an external profile dimension of the anode composite layer is at least 1000 mm.

A bipolar electrode of a twelfth aspect is any one of the first aspect to the eleventh aspect, wherein there are more grooves at a center region of the anode composite layer than at an outside region of the anode composite layer.

A bipolar electrode of a thirteenth aspect is any one of the first aspect to the twelfth aspect, wherein grooves are provided uniformly at the anode composite layer.

A bipolar electrode of a fourteenth aspect is any one of the first aspect to the thirteenth aspect, wherein the groove is not provided to the cathode composite layer.

A bipolar battery of a fifteenth aspect is a bipolar battery including plural of the bipolar electrodes of any one of the first aspect to the fourteenth aspect stacked with a separator formed from an organic material interposed between adjacent bipolar electrodes of the plurality of bipolar electrodes, and an electrolytic solution.

A bipolar electrode and a bipolar battery of the present disclosure are able to suppress warping from developing during charging and discharging.

### BRIEF DESCRIPTION OF THE DRAWINGS

Exemplary embodiments of the present invention will be described in detail based on the following figures, wherein:

FIG. 1 is a schematic cross-section illustrating a configuration of a bipolar electrode according to a first exemplary embodiment of the present disclosure;

FIG. 2 is a plan view of an anode composite layer of the bipolar electrode of FIG. 1, as viewed from above in a stacking direction;

FIG. 3 is a schematic cross-section illustrating a configuration of a bipolar battery according to an exemplary embodiment of the present disclosure;

FIG. 4 is a schematic cross-section illustrating an internal configuration of a power storage module illustrated in FIG. 3;

FIG. 5 is an enlargement of a location encircled by A in FIG. 1;

FIG. 6 is an enlargement corresponding to FIG. 5 during charging and discharging;

FIG. 7 is a plan view of an anode composite layer of a bipolar electrode according to a second exemplary embodiment of the present disclosure, as viewed from above in the stacking direction;

FIG. 8 is a schematic cross-section to explain a definition of warping; and

FIG. 9 is a schematic cross-section illustrating a configuration of a related bipolar electrode.

### DETAILED DESCRIPTION

### First Exemplary Embodiment

Description follows regarding a bipolar electrode 10 according to a first exemplary embodiment of the present disclosure, with reference to the drawings. The same reference numerals are employed for the same or equivalent elements in the description of the drawings, and duplicate explanation thereof is omitted.

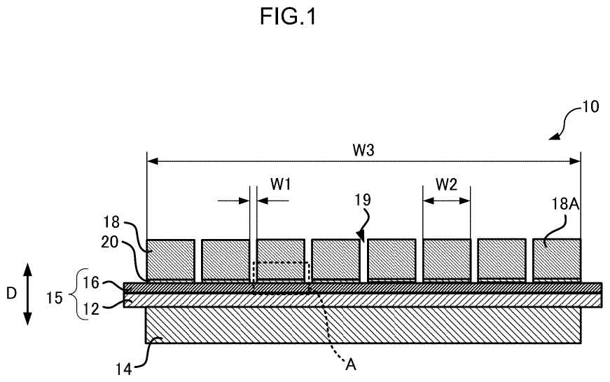

FIG. 1 is a schematic cross-section illustrating a configuration of the bipolar electrode 10. The bipolar electrode 10 illustrated in FIG. 1 is an electrode having, as an example, a bipolar structure, and is employed in a bipolar battery 1 serving as a power storage device, described later.

The bipolar electrode 10 is formed in a substantially cuboidal shape. The bipolar electrode 10 includes a cathode substrate 12 configuring a current collector 15, a cathode composite layer 14 formed on the cathode substrate 12, an anode substrate 16 configuring the current collector 15, an anode composite layer 18 formed on the anode substrate 16, and an elastic layer 20 formed between the anode substrate 16 and the anode composite layer 18. In the present exemplary embodiment the current collector 15 is formed by sticking the cathode substrate 12 and the anode substrate 16 together.

The bipolar electrode 10 is configured by stacking the cathode composite layer 14, the cathode substrate 12, the anode substrate 16, the elastic layer 20, and the anode composite layer 18 in this sequence from the bottom of the page of FIG. 1 toward the top of the page. In the present exemplary embodiment, a page height direction of FIG. 1, namely a direction of stacking the cathode composite layer 14, the cathode substrate 12, the anode substrate 16, the elastic layer 20, and the anode composite layer 18, is referred to as “stacking direction D”.

The cathode substrate 12 is, for example, formed from a rectangular sheet shaped metal foil, and in the present exemplary embodiment is specifically formed from an aluminum foil. The cathode substrate 12 is, for example, a chemically inactive electrical conductor that lets current continue to flow to the cathode composite layer 14 during charging or discharging of the bipolar battery 1.

The cathode composite layer 14 is formed to a lower face of the cathode substrate 12 on the lower side in the stacking direction D, and is formed inside a peripheral edge of the cathode substrate 12. Namely, a peripheral edge portion 12A of the cathode substrate 12 is formed in a rectangular frame shape, and is a non-coated region not coated with the cathode composite layer 14. The cathode composite layer 14 is a cathode active material layer formed by coating a cathode active material in a substantially rectangular shape onto a lower face of the cathode substrate 12. Examples of cathode active materials configuring the cathode composite layer 14 include, for example, oxide active materials. Examples of such oxide active materials include, for example, layered rock salt structure type active materials such as LiCoO2, LiMnO2, LiNiO2, LiVO2, LiNi1/3Co1/3Mn1/3O2 and the like, spinel type active materials such as LiMn2O4, Li(Ni0.5Mn1.5)O4 and the like, and olivine type active materials such as LiFePO4, LiMnPO4, LiNiPO4, LiCuPO4, and the like. The cathode active material layer forming the cathode composite layer 14 may contain a conductive material and a binder as well as a cathode active material.

The anode substrate 16 is, as an example, formed from a rectangular sheet shaped metal foil, and in the present exemplary embodiment is specifically formed from a copper foil. The anode substrate 16 is, for example, a chemically inactive electrical conductor that lets current continue to flow to the anode composite layer 18 during charging or discharging of the bipolar battery 1. Note that in the present exemplary embodiment the anode substrate 16 is, as an example, provided with fine pores of a diameter q1 of from 5 μm to 20 μm by using an etching treatment. Note that the anode substrate 16 may, instead of fine pores, be provided with grooves having a width q2 of from 5 μm to 20 μm by using an etching treatment.

The anode composite layer 18 is formed on a stacking direction D upper face of the anode substrate 16, and is formed inside a peripheral edge of the anode substrate 16. Namely, a peripheral edge 16A of the anode substrate 16 forms a rectangular frame shape, and is a non-coated region not coated with the anode composite layer 18. The anode composite layer 18 is an anodic active material layer formed by coating an anodic active material onto the upper face of the anode substrate 16. Examples of the anodic active material configuring the anode composite layer 18 include, for example, carbon active materials, oxide active materials, and metal active materials.

In the present exemplary embodiment, the anode composite layer 18 specifically contains silicon (Si) at 10% or less against a graphite based anodic active material. Moreover, in the present exemplary embodiment, the anode composite layer 18 is formed with a thickness of from 100 μm to 200 μm. Note that the cathode composite layer 14 is formed with a thickness less than that of the anode composite layer 18. Specifically, for example, a volume ratio of the anode composite layer 18 with respect to the cathode composite layer 14 is in a range of from 1.05 to 1.2.

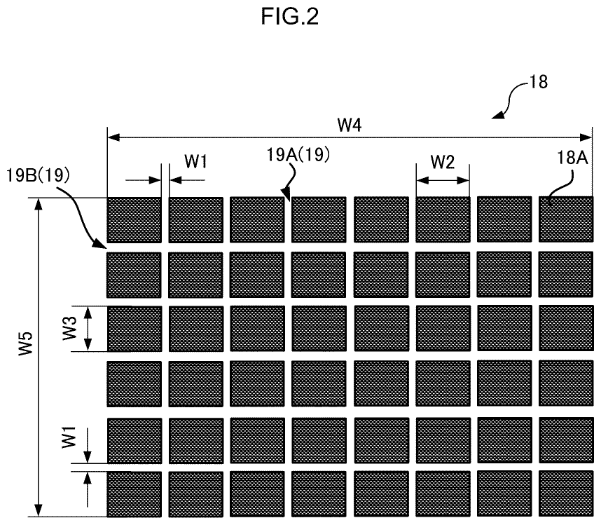

FIG. 2 is a plan view of the anode composite layer 18 of the bipolar electrode 10 of FIG. 1, as viewed from above in the stacking direction D. As illustrated in FIG. 2, the anode composite layer 18 includes plural regions 18A formed on the anode substrate 16. Namely, the anode composite layer 18 is divided into plural regions 18A. In the present exemplary embodiment, the anode composite layer 18 is, as an example, divided into 8 columns disposed along the page left-right direction and 6 rows disposed along the page height direction, a total of 48 of the regions 18A.

Grooves 19 are provided in the stacking direction D upper face of the anode composite layer 18 between adjacent regions 18A. In the present exemplary embodiment, as illustrated in FIG. 2, the anode composite layer 18 is formed in substantially rectangular shape when viewed from above in the stacking direction D, and each of the plural grooves 19 is formed in a line shape extending along the surface of the anode composite layer 18 at short edge sides and long edge sides of the anode composite layer 18. Namely, longitudinal grooves 19A that extend in the page height direction extend substantially parallel to short edges of the anode composite layer 18, and lateral grooves 19B that extend in the page width direction extend substantially parallel to long edges of the anode composite layer 18. Note that the grooves 19 (the longitudinal grooves 19A and the lateral grooves 19B) in the present exemplary embodiment are illustrated as locations on the stacking direction D upper face of the anode substrate 16 not carrying the anode composite layer 18. Namely, bottom portions of the grooves 19 are configured by the anode substrate 16.

The grooves 19 are, as an example, formed by laser beam machining. The grooves 19 are difficult to form by a coating process due to having a narrow width, and so laser beam machining is employed from the perspective of case of processing.

As an example, the longitudinal grooves 19A and the lateral grooves 19B preferably have a groove width W1 that is from 50 μm to 5 mm, and that is more preferably from 50 μm to 1 mm. Note that the groove width W1 is made to be a necessary size that depends on the content of silicon in the anode composite layer 18, and the groove width W1 is set to an appropriate value according to the silicon content of the anode composite layer 18. Moreover, the longitudinal grooves 19A, as an example, preferably have a spacing between adjacent grooves W2 of from 1 mm to 100 mm, and more preferably of from 1 mm to 20 mm. Similarly, the lateral grooves 19B, as an example, preferably have a spacing between adjacent grooves W3 of from 1 mm to 100 mm, and more preferably of from 1 mm to 20 mm. Note that the spacing between adjacent grooves W2 and W3 are the same values as the widths of the regions 18A interposed between adjacent grooves.

Moreover, proportions of the groove width W1 with respect to the spacing between adjacent grooves W2 and W3 (W1/W2, W1/W3) are both preferably 0.05. Note that for convenience in the present exemplary embodiment the groove widths W1 of the longitudinal grooves 19A and the lateral grooves 19B are indicated with the same reference numeral, however the sizes of the groove widths W1 of the longitudinal grooves 19A and the lateral grooves 19B may be different. The groove width W1 is set according to the values of the spacing between the adjacent grooves W2 and W3.

Moreover, the grooves 19 are, as an example, provided uniformly at the anode composite layer 18. Namely, the longitudinal grooves 19A are disposed at a uniform rate along the long edge of the anode composite layer 18, and the lateral grooves 19B are disposed at a uniform rate along the short edge of the anode composite layer 18.

Moreover, the lateral width W4 and height wise width W5 that are the external dimensions of the anode composite layer 18 may be 1000 mm or greater.

In the present exemplary embodiment, the grooves 19 are provided to the anode composite layer 18, however grooves 19 may be provided to the cathode composite layer 14.

The elastic layer 20 contains a conductive auxiliary agent and a polymer material, with the stacking direction D upper side thereof adhered to the anode composite layer 18, and the lower side thereof adhered to the anode substrate 16. The conductive auxiliary agent is contained to raise the electrical conductivity of the elastic layer 20 and, for example, acetylene black, carbon black, graphite, or the like may be employed therefor. A known material may be employed as the polymer material and, as an example, polyethylene, polypropylene, polyethylene terephthalate, polyacylonitrile, poly(methyl metacrylate), polyvinylidene fluoride, or the like may be employed therefor. The elastic layer 20 is formed at a thickness of 10 μm or less.

In the present exemplary embodiment, the elastic layer 20 exhibits, as an example, both clastic properties and adhesiveness. Specifically, the elastic layer 20 is, as an example, formed so as to have a tensile-shear adhesive strength of from 15 MPa to 40 MPa, a peel adhesive strength of from 3 N to 10 N, a modulus of elasticity of from 700 MPa to 1200 MPa, a breaking strength of from 15 MPa to 25 MPa, an elongation percentage at breaking of from 5% to 30%, and an electron conductivity of 1 mS/cm. For a current collector foil configured by a set of a cathode foil (cathode substrate) and an anode foil (anode substrate) employed in the bipolar battery, hitherto the anode composite layer and the anode foil would not be able to expand together, however inserting such an elastic layer between the anode composite and the anode foil enables them to follow while sliding with respect to each other. In an all-solid-state battery, such an elastic layer is redundant because the anode current collector foil and the anode composite expand and contract together.

Next, description follows regarding an example of a bipolar battery 1 configured by plural of the bipolar electrodes 10 described above that have been stacked together. Note that the same reference numerals are employed for the same or equivalent elements in the description of the drawings, and duplicate explanation thereof is omitted.

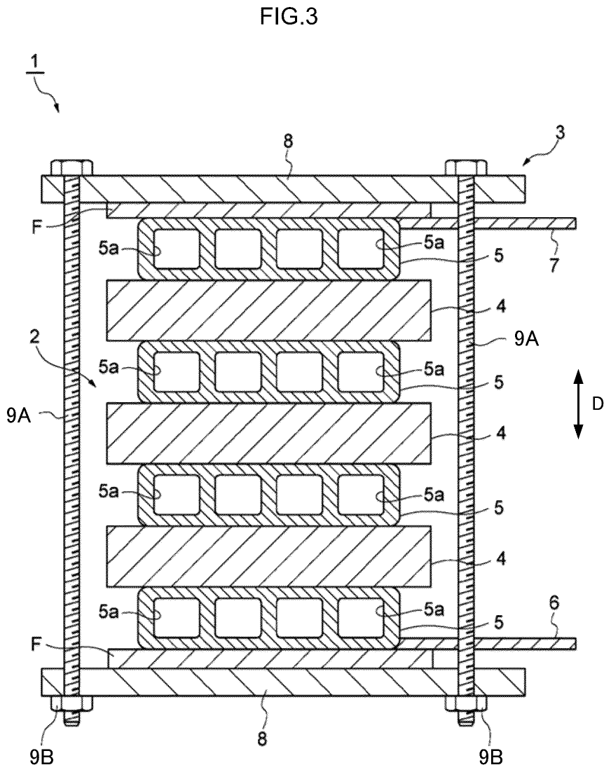

FIG. 3 is a schematic cross-section illustrating a configuration of a bipolar battery 1 according to an exemplary embodiment. The bipolar battery 1 illustrated in FIG. 1 is, for example, a device employed as a battery in various vehicle, such as in a forklift truck, a hybrid car, an electric car, or the like. The bipolar battery 1 is, for example, a secondary battery such as a nickel hydrogen secondary battery, a lithium ion secondary battery, or the like. In the present exemplary embodiment, an example will be described for a case in which the bipolar battery 1 is a liquid lithium ion secondary battery. The bipolar battery 1 includes a module stack assembly 2, and a restraining member 3 that imparts restraining load to the module stack assembly 2 in the stacking direction of the module stack assembly 2.

The module stack assembly 2 includes plural power storage modules 4, and plural conductor plates 5. The module stack assembly 2 is configured by alternately stacking the plural (in this case 3) power storage modules 4, and the plural (in this case 4) conductor plates 5, such that there is a conductor plate 5 positioned at both sides of each of the power storage modules 4. The direction of stacking the power storage modules 4 is referred to as “stacking direction D”. The power storage modules 4 are bipolar batteries, and are formed in rectangular shapes as viewed from the stacking direction D.

The power storage modules 4 that are adjacent to each other in the stacking direction D are electrically connected through the respective conductor plate 5. The conductor plates 5 are respectively disposed between the power storage modules 4 that are adjacent to each other in the stacking direction D and at the outside of the power storage modules 4 positioned at the ends of the stack. An anode terminal 6 is connected to one of the conductor plates 5 disposed at the outside of the power storage module 4 positioned at one end of the stack. A cathode terminal 7 is connected to another of the conductor plates 5 disposed at the outside of the power storage module 4 positioned at the other end of the stack. The anode terminal 6 and the cathode terminal 7 are, for example, each led out from an edge portion of the respective conductor plate 5 in a direction that intersects with the stacking direction D. Charging and discharging of the bipolar battery 1 is executed using the anode terminal 6 and the cathode terminal 7.

Note that although in the present exemplary embodiment the outermost layers of the module stack assembly 2 are configured by conductor plates 5, the outermost layers (stack outermost layers) of the module stack assembly 2 may each be configured by a power storage module 4. In such cases the anode terminal 6 and/or the cathode terminal 7 is connected to the power storage module 4 configuring the stack outermost layer(s).

Plural flow paths 5a that let a coolant such as air or the like flow through are provided inside each of the conductor plates 5. The flow paths 5a extend, for example, along directions respectively intersecting with (orthogonal to) the stacking direction D and intersecting with the lead-out direction of the anode terminal 6 and the cathode terminal 7. The conductor plates 5 each have a combined function of a function as a connection member to electrically connect power storage modules 4 together, as well as a function as a heat dissipation plate to dissipate heat generated by the power storage modules 4, by letting coolant flow through the flow paths 5a therein.

The restraining member 3 includes a pair of end plates 8 that sandwich the module stack assembly 2 in the stacking direction D, and fastening bolts 9A and nuts 9B to fasten the end plates 8 together. A film F having electrically insulating properties is provided to faces of the end plates 8 on the module stack assembly 2 side, and the end plates 8 and the conductor plates 5 are electrically insulated from each other by the film F.

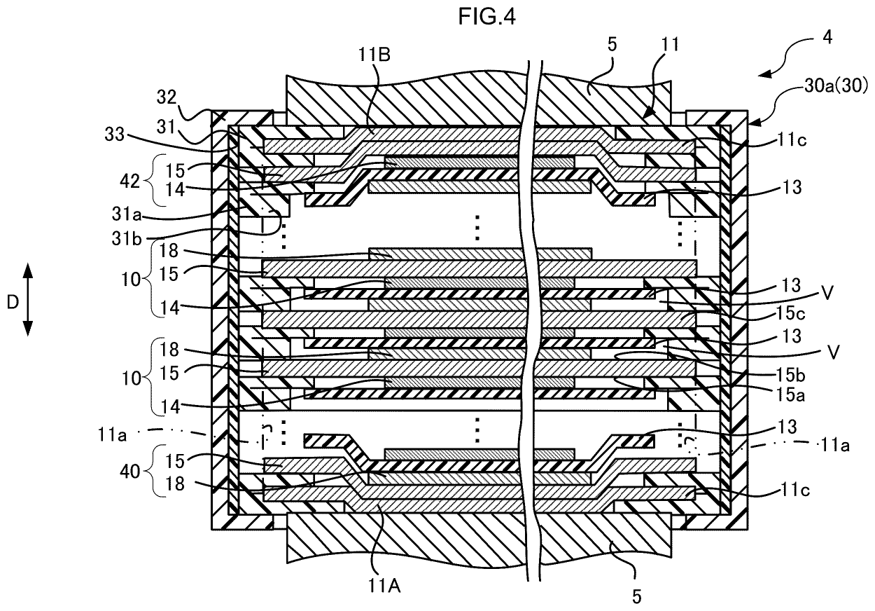

Next, detailed description follows regarding a configuration of the power storage modules 4. FIG. 4 is a schematic cross-section illustrating an internal configuration of the power storage modules 4 illustrated in FIG. 3. As illustrated in FIG. 4, each of the power storage modules 4 includes an electrode stack assembly (cell stack) 11, and a resin sealing body 30 that seals the electrode stack assembly 11. The power storage modules 4 are each, for example, formed in a cuboidal shape.

The electrode stack assembly 11 includes plural electrodes that are stacked along the stacking direction D with separators 13 interposed therebetween, and includes current collectors (metal plates 11A, 11B) positioned at the stack ends of the electrode stack assembly 11. The plural electrodes include a cathode terminal electrode 40, an anode terminal electrode 42, and plural bipolar electrodes 10 stacked between the cathode terminal electrode 40 and the anode terminal electrode 42. A stack assembly configured from the plural bipolar electrodes 10 is provided between the cathode terminal electrode 40 and the anode terminal electrode 42.

Each of the bipolar electrodes 10 includes a current collector 15 including a one-face 15a and an other-face 15b provided on the opposite side to the one-face 15a, a cathode composite layer 14 serving as a cathode provided on the one-face 15a, and an anode composite layer 18 serving as an anode provided on the other-face 15b. The one-face 15a is a face facing in one direction of the stacking direction D, for example facing downward in the direction of gravity. The other-face 15b is a face facing in the other direction of the stacking direction D, for example facing upward in the direction of gravity.

Note that although omitted from illustration in FIG. 4, the current collector 15 of the bipolar electrode 10 includes the cathode substrate 12 and the anode substrate 16, as described above with reference to FIG. 1 and FIG. 2. Moreover, the grooves 19 are formed in the anode composite layer 18, and the elastic layer 20 is provided between the anode substrate 16 and the anode composite layer 18.

In the electrode stack assembly 11, the cathode composite layer 14 of one of the bipolar electrodes 10 faces toward the anode composite layer 18 of a separate bipolar electrode 10 adjacent in the one stacking direction D, with a separator 13 interposed therebetween. In the electrode stack assembly 11, the anode composite layer 18 of one of the bipolar electrodes 10 faces toward the cathode composite layer 14 of a separate bipolar electrode 10 adjacent in the other stacking direction D, with a separator 13 interposed therebetween.

The cathode terminal electrode 40 includes the current collector 15, and the anode composite layer 18 provided on the other-face 15b of the current collector 15. The cathode terminal electrode 40 is disposed at the one stacking direction D end side of the electrode stack assembly 11 such that the other-face 15b of the cathode terminal electrode 40 faces toward the stacking direction D center. A metal plate 11A is furthermore stacked on the one-face 15a of the current collector 15 of the cathode terminal electrode 40, with one conductor plate 5 adjacent to the power storage module 4 electrically connected thereto through the metal plate 11A. The anode composite layer 18 provided to the other-face 15b of the current collector 15 of the cathode terminal electrode 40 opposes, across the separator 13, the cathode composite layer 14 of the bipolar electrode 10 at the one stacking direction D end.

The anode terminal electrode 42 includes the current collector 15, and the cathode composite layer 14 provided to the one-face 15a of the current collector 15. The anode terminal electrode 42 is disposed at the other stacking direction D end side of the electrode stack assembly 11 such that the one-face 15a of the anode terminal electrode 42 faces toward the stacking direction D center. A metal plate 11B is furthermore stacked on the other-face 15b of the current collector 15 of the anode terminal electrode 42, with another conductor plate 5 adjacent to the power storage module 4 electrically connected thereto through the metal plate 11B. The cathode composite layer 14 provided to the one-face 15a of the current collector 15 of the anode terminal electrode 42 opposes, across the separator 13, the anode composite layer 18 of the bipolar electrode 10 at the other stacking direction D end.

In the present exemplary embodiment, a region where the anode composite layer 18 is formed on the other-face 15b of the current collector 15 is configured so as to be one size larger than a region where the cathode composite layer 14 is formed on the one-face 15a of the current collector 15. The electrode stack assembly 11 includes the plural current collectors 15, the metal plate 11A, and the metal plate 11B that have been stacked together.

Each of the separators 13 is a member to prevent shorting between current collectors 15, and is formed from an organic material in, for example, a sheet shape. Examples of the separator 13 include porous films made from a poly olefin resin such as polyethylene (PE), polypropylene (PP), or the like, and woven or non-woven fabrics or the like made from polypropylene, methylcellulose, or the like. The separator 13 may be reinforced by a vinylidene fluoride resin compound. Note that the separator 13 is not limited to being sheet shaped, and a bag shaped separator may also be employed.

The metal plates 11A, 11B are members substantially the same as the current collectors 15. The metal plates 11A, 11B are non-coated electrodes, with both surfaces thereof not coated with an active material layer. Due to the presence of the metal plate 11A, the cathode terminal electrode 40 is in a state disposed along the stacking direction D between the metal plate 11A and one of the bipolar electrodes 10. The metal plate 11A and the current collector 15 of the cathode terminal electrode 40 are electrically connected together by direct contact without anything being interposed therebetween. Due to the presence of the metal plate 11B, the anode terminal electrode 42 is in a state disposed along the stacking direction D between the metal plate 11B and one of the bipolar electrodes 10. The metal plate 11B and the current collector 15 of the anode terminal electrode 42 are electrically connected together by direct contact without anything being interposed therebetween.

In the electrode stack assembly 11, a central region of the electrode stack assembly 11 (a region where the active material layers are disposed in the bipolar electrodes 10, the cathode terminal electrode 40, and the anode terminal electrode 42) bulges more in the stacking direction D than the surrounding region. This means that the metal plates 11A, 11B are bent in a direction such that the central regions of the metal plates 11A, 11B separate from each other. The central region of the lower face of the metal plate 11A and the central region of the upper face of the metal plate 11B contact respective conductor plates 5.

The sealing body 30 is, for example, formed from a resin with insulating properties in an overall rectangular tube shape. The sealing body 30 is, for example, formed in a rectangular tube shape including a pair of short edge portions 30a, and a pair of long edge portions (omitted in the drawings). The sealing body 30 is provided so as to surround side faces 11a of the electrode stack assembly 11. The sealing body 30 retains an edge portion 15c of each of the current collectors 15 at the side faces 11a.

The sealing body 30 includes plural frame shaped first sealing portions 31 (resin portions) respectively provided to edge portions of the metal plates included in the electrode stack assembly 11 (namely, to the edge portions 15c of the current collectors 15 and to edge portions 11c of the metal plates 11A, 11B), and a second sealing portion 32 wraps along the side faces 11a around the first sealing portions 31 from the outside and is joined to the respective first scaling portions 31. The first sealing portions 31 and the second sealing portion 32 are, for example, made from a resin with insulating properties, and examples of materials configuring the resin include, for example, polypropylene (PP), polyphenylenc sulfide (PPS), modified polyphenylene ether (modified PPE), and the like.

The first sealing portions 31 are provided contiguously around the entire periphery of the edge portions 15c of the current collector 15 and the edge portions 11c of the metal plates 11A, 11B, so as to form a rectangular frame shape as viewed from the stacking direction D. The first sealing portions 31 and the current collectors 15, and the first scaling portions 31 and the metal plates 11A, 11B, are respectively joined together airtightly. The first scaling portions 31 extends further toward the outside than the edge portions 15c of the current collectors 15 and the edge portions 11c of the metal plates 11A, 11B as viewed along the stacking direction D. The first sealing portions 31 include outside portions 31a jutting further outside than edges of the current collectors 15 and the metal plates 11A, 11B, and include inside portions 31b positioned further to the inside that edges of the current collectors 15 and the metal plates 11A, 11B. A weld layer 33 is formed at leading end portions (outer edge portions) of the outside portions 31a of the first sealing portions 31.

In the present exemplary embodiment, the first sealing portions 31 are formed in a double-layer structure by folding a single sheet of film in two. The outer edge portions of the first sealing portions 31 embedded in the second sealing portion 32 are fold-back portions (bent portions) of the film. The edge portions of the metal plates included in the electrode stack assembly 11 (namely, the edge portions 15c of the current collectors 15 and the edge portions 11c of the metal plates 11A, 11B) are retained from both stacking direction D sides by the inside portions 31b of a first layer of the film configuring the first sealing portions 31 and a second layer of the film. Specifically, the plural first sealing portions 31 are respectively joined to the one-face 15a of the current collectors 15 and joined to the outside faces of the metal plate 11A and the metal plate 11B. Note that the plural first sealing portions 31 may be furthermore joined to the inside faces of the one-face 15a of the current collector 15 and joined to the inside faces of the metal plate 11A and the metal plate 11B.

Note that although in the present exemplary embodiment the first sealing portions 31 are each configured from a single sheet of film, the present disclosure is not limited thereto, and they may each be configured from two sheets of film. Namely, the first layer of the film and the second layer of the film may be formed by separate bodies. In such cases the peripheral edge portion sides of the first layer of the film and the second layer of the film are joined together.

The second sealing portion 32 retains the outer peripheral portions of the plural first sealing portions 31. Specifically, the second sealing portion 32 integrates the outer peripheral portions of the plural first sealing portions 31 by being welded to portions where the plural first sealing portions 31 are superimposed in the stacking direction so as to configure the weld layer 33.

There are plural internal voids V provided inside the electrode stack assembly 11. Each of the internal voids V is provided between adjacent metal plates. The internal voids V are spaces between metal plates that are adjacent the stacking direction D, and are bounded by the metal plates and the sealing body 30 both airtightly and liquid-tightly. An electrolytic solution (omitted in the drawings) is, for example, housed in the internal voids V. This electrolytic solution contains, for example, a non-aqueous solvent and a support salt. Examples of the non-aqueous solvent include, for example, organic solvents such as carbonates, ethers, esters, nitriles, sulfones, lactones, and the like. Examples of support salts include, for example, lithium salts such as LiPF6 or the like. The electrolytic solution impregnates the separators 13, the cathode composite layers 14, and the anode composite layers 18.

Note that in the bipolar battery 1 liquid injection ports (omitted in the drawings) are provided to one of the short edge portions 30a of the sealing body 30. The liquid injection ports pass through the sealing body 30 in the long edge direction of the sealing body 30. The liquid injection ports communicate the internal voids V with external space. The positions where the liquid injection ports are provided on the one short edge portion 30a of sealing body 30 differ according to corresponding positions of the internal voids V in the stacking direction D (see FIG. 4). The liquid injection ports are provided displaced in the short edge direction of the sealing body 30 such that adjacent liquid injection ports in the stacking direction D (see FIG. 4) do not overlap with each other.

Next, description follows regarding operation and advantageous effects of the bipolar battery 1 of the first exemplary embodiment.

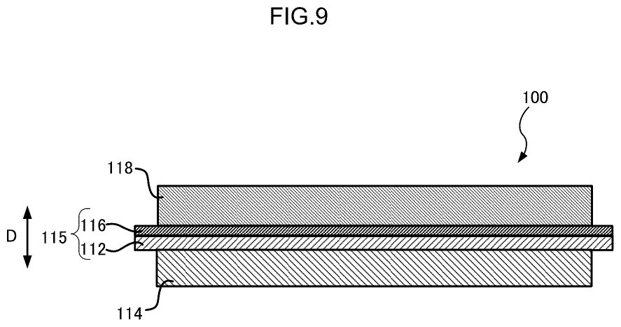

A related bipolar battery will now be described. FIG. 9 is a schematic cross-section illustrating a configuration of a related bipolar electrode 100. The related bipolar electrode 100 includes composite layers (a cathode composite layer 114 and an anode composite layer 118) that are disposed on each of the stacking direction D faces of a current collector 115 and that have different expansion and contraction behaviors during charging and discharging. Specifically, the amount of expansion of the bipolar electrode 100 on the anode composite layer 118 side increases during charging of a bipolar battery, whereas the bipolar electrode 100 contracts during charging on the cathode composite layer 114. Note that “amount of expansion” indicates an amount of extension in an in-plane direction (a direction substantially orthogonal to the stacking direction D).

In the bipolar electrode 100, the cathode composite layer 114 and the anode composite layer 118 are both directly disposed on the current collector 115, and so when a stress difference arises due to different amounts of expansion thereof as they sandwich the current collector 115, a force acts to stretch the current collector 115 accompanying the expansion and contraction of the composite layers, with this leading to a possibility that warping (undulations) develop in the bipolar electrode 100 during charging and discharging of the bipolar battery. In particular, there is a large amount of displacement of the composite layers in cases in which the composite layers (the cathode composite layer 114 and the anode composite layer 118) are thick, and warping due to pressure difference is expected to be particularly significant.

In contrast thereto, each of the bipolar electrodes 10 of the present exemplary embodiment includes the cathode substrate 12 configuring the current collector 15, the cathode composite layer 14 formed on the cathode substrate 12, the anode substrate 16 configuring the current collector 15, the anode composite layer 18 formed on the anode substrate 16 and divided into the plural regions 18A with the grooves 19 provided between the adjacent regions 18A, and the elastic layer 20 having elastic properties formed between the anode substrate 16 and the anode composite layer 18. Moreover, the bipolar electrodes 10 each include the cathode composite layer 14, the cathode substrate 12, the anode substrate 16, the elastic layer 20, and the anode composite layer 18 stacked in this sequence in the stacking direction D.

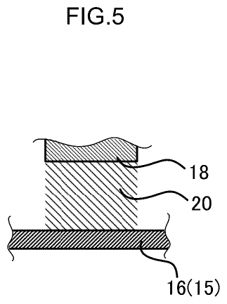

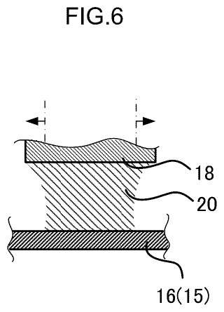

FIG. 5 is an enlargement of a location encircled by A in FIG. 1, and FIG. 6 is an enlargement corresponding to FIG. 5 during charging and discharging. As illustrated in FIG. 5, the bipolar electrodes 10 of the present exemplary embodiment each include the elastic layer 20 interposed between the anode substrate 16 and the anode composite layer 18. Thus as illustrated in FIG. 6, the elastic layer 20 stretches when the anode composite layer 18 is stretched to match the stretching of the anode composite layer 18. This thereby enables the effect of stretching of the anode composite layer 18 to be suppressed from being transmitted to the anode substrate 16, namely to the current collector 15.

Due to suppressing the effect of stretching of the anode composite layer 18 from being transmitted to the current collector 15 in this manner, warping (undulations) in the bipolar electrodes 10 can be suppressed from developing during charging and discharging of the bipolar battery 1.

Note that in the present exemplary embodiment the elastic layer 20 is formed with a thickness of 10 μm or less. Were the thickness of the clastic layer 20 to be thicker than 10 μm in the bipolar electrodes 10 then it would be difficult to exchange electrons across the clastic layer 20 between the anode substrate 16 and the anode composite layer 18. When the thickness of the elastic layer 20 is 10 μm or less then this facilitates exchange of electrons across the clastic layer 20 between the anode substrate 16 and the anode composite layer 18.

In the present exemplary embodiment the elastic layer 20 contains the conductive auxiliary agent and the polymer material. Containing the conductive auxiliary agent and the polymer material in the elastic layer 20 in this manner facilitates exchange of electrons across the elastic layer 20 between the anode substrate 16 and the anode composite layer 18. This thereby enables high speed charging and discharging performance of the anode to be raised, and anode capacitance is raised as a result.

Moreover, the elastic layer 20 is formed so as to have a tensile-shear adhesive strength of from 15 MPa to 40 MPa, a peel adhesive strength of from 3 N to 10 N, a modulus of elasticity of from 700 MPa to 1200 MPa, a breaking strength of from 15 MPa to 25 MPa, an elongation percentage at breaking of from 5% to 30%, and an electron conductivity of 1 mS/cm. Proportional elongation of the anode composite layer 18 along the in-plane direction is able to be appropriately absorbed due to the elastic layer 20 formed in this manner being interposed between the anode substrate 16 and the anode composite layer 18.

Moreover, in the present exemplary embodiment the grooves 19 are provided in the stacking direction D upper face of the anode composite layer 18 as described above (see FIG. 1 and FIG. 2). The grooves 19 of the present exemplary embodiment are designed to decrease the amount of expansion of the anode composite layer 18 and so there is a need for comparatively more grooves than, for example, the grooves employed for liquid injection described in Patent Document 1. This means that the shape, number, size, and the like of the grooves differ from, for example, those of the grooves described in Patent Document 1. Namely, the surface area of each of the regions 18A in the anode composite layer 18 can be made smaller by making more regions of grooves 19, enabling the amount of expansion of each of the regions 18A to be made smaller.

Moreover, in the present exemplary embodiment, the anode composite layer 18 contains silicon (Si) at 10% or less with respect to a graphite based anodic active material. Investigations by the inventors of the present application have found that in an anode composite layer 18 having a silicon content of 10% or less with respect to a graphite based anodic active material, the proportional expansion thereof in the in-plane direction is about 2.5% during charging of the bipolar battery 1. This means that the groove width W1 needs to be about 5% of 10 mm when the coated surface area of the anode composite layer 18 on the anode substrate 16 is a rectangular shape having an edge of 10 mm. Making the above coated surface area smaller would enable the groove width W1 to be smaller, however if the coated surface area is too small then this raises the difficulty of machining the grooves 19, and also leads to a concern regarding irregularities in battery reaction due to an increase in edges of the anode composite layer 18 at portions not opposing the cathode composite layer 14 due to the anode composite layer 18 being finely divided. The dimensions of the grooves 19 are accordingly set in consideration of a trade-off against the advantageous effects thereof.

In the present exemplary embodiment, the anode composite layer 18 is formed with a thickness of from 100 μm to 200 μm. The lateral width W4 and the height wise width W5 that define the external profile dimension of the anode composite layer 18 are formed so as to be at least 1000 mm. The volume ratio of the anode composite layer 18 with respect to the cathode composite layer 14 is in the range of from 1.05 to 1.2. The anode composite layer 18 is divided into the 48 regions 18A. Moreover, the grooves 19, namely the longitudinal grooves 19A and the lateral grooves 19B preferably, as an example, have a groove width W1 of from 50 μm to 5 mm, and more preferably of from 50 μm to 1 mm. The longitudinal grooves 19A, as an example, preferably have a spacing between adjacent grooves W2 of from 1 mm to 100 mm, and more preferably from 1 mm to 20 mm.

Similarly, the lateral grooves 19B, as an example, preferably have a spacing between adjacent grooves W3 of from 1 mm to 100 mm, and more preferably from 1 mm to 20 mm. Moreover, proportions of the groove width W1 with respect to the spacing between adjacent grooves W2 and W3 (W1/W2, W1/W3) are both preferably 0.05. Setting the grooves 19 in this manner is more preferable from the perspective of making the amount of expansion of the anode composite layer 18 small, from the perspective of case of machining, and from the perspective of suppressing irregularities in battery reaction.

Moreover, the grooves 19 are, as an example, provided uniformly at the anode composite layer 18. Providing the grooves 19 uniformly in this manner facilitates achieving uniform electrolytic solution diffusion when injecting the electrolytic solution, and so is preferable from the perspective of liquid injectability.

Moreover, in the present exemplary embodiment, the grooves 19 are not provided to the cathode composite layer 14. The amount of expansion in the cathode composite layer 14 is not suppressed due to not providing the grooves 19 in the cathode composite layer 14, and so an expansion and contraction difference between the cathode composite layer 14 and the anode composite layer 18 during charging and discharging can be suppressed, enabling warping to be suppressed from developing in the bipolar electrodes 10.

### Second Exemplary Embodiment

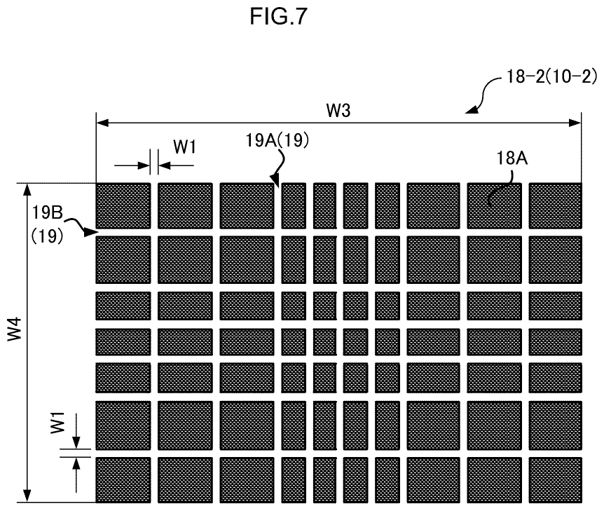

Description follows regarding a bipolar electrode 10-2 according to a second exemplary embodiment of the present disclosure, with reference to the drawings. Note that in the bipolar electrode 10-2 of the second exemplary embodiment, the same reference numerals are employed to indicate configuration similar to that of the bipolar electrode 10 of the first exemplary embodiment as described above with duplicate description omitted thereof, and detailed description follows only of locations that differ therefrom. The bipolar electrode 10-2 of the second exemplary embodiment differs in that the configuration of an anode composite layer 18-2 is different from the anode composite layer 18 in the first exemplary embodiment described above. FIG. 7 is a plan view of the anode composite layer 18-2 of the bipolar electrode 10-2 according to the second exemplary embodiment, as viewed from above in the stacking direction.

In contrast to the anode composite layer 18 of the first exemplary embodiment described above in which the grooves 19 are provided uniformly, in the anode composite layer 18-2 of the second exemplary embodiment more grooves 19 are provided at a center region of the anode composite layer 18-2 than at an outside region thereof, as illustrated in FIG. 7. Namely, plural divided regions 18A in the anode composite layer 18-2 are formed such that regions 18A positioned in the center region of the anode composite layer 18-2 are smaller than in the outside region thereof.

The grooves 19 are preferably provided uniformly from the perspective of liquid injectability. However, by providing more grooves 19 at a center region of the anode composite layer 18-2 than at an outside region thereof as in the present exemplary embodiment, the amount of expansion of the center region of the anode composite layer 18-2 can be suppressed further, which is preferable from the perspective of suppressing warping from developing during charging and discharging.

Note that although the anode composite layer 18-2 of the second exemplary embodiment has different numbers of grooves 19 in the outside region of the anode composite layer 18-2 to in the inside region as illustrated in FIG. 7, the present disclosure is not limited thereto. For example, the number of grooves 19 may be set so as to be progressively more toward the inside. Moreover, a configuration may be adopted in which more grooves 19 are provided in the center region than in the outside region for only one from out of the longitudinal grooves 19A and the lateral grooves 19B.

Moreover, the dimensions of the bipolar electrodes 10, 10-2 in the bipolar battery 1 according to the exemplary embodiments of the present disclosure are not particularly limited.

Moreover, the configuration of the present disclosure is not limited to the above exemplary embodiments, and appropriate configuration changes may be made while still being able to address the above issues.

The present disclosure will now be more specifically described by way of a working example and comparative examples. Note that the present disclosure is not limited by the working example.

### Negative Electrode Fabrication

The negative electrode is an electrode including the anode substrate 16 and the anode composite layer 18.

### Comparative Example 1

First, an anodic active material (artificial zinc) and a silicon active material, a binder (styrene-butadiene rubber (SBR) and thickener (carboxymethyl cellulose (CMC)), and a conductive auxiliary agent (carbon nanotubes (CNT)) were mixed together to achieve a ratio of 92.95:5:1:1:0.05 by weight %, then after adding distilled water, the material was well kneaded using a kneader to obtain an anode paste. The anode composite layer 18 was produced by coating the anode paste onto a copper foil serving as a current collector (anode substrate 16) using a doctor blade, and drying for 15 minutes in an environment of 100° C. to evaporate off all the water. When doing so, the post drying carried amount of the anode composite layer 18 was adjusted so as to be 26 mg/cm². The produced negative electrode was subjected to biaxial roll pressing to obtain a negative electrode such that the density was from 1.2 to 1.4 g/cc.

### Comparative Example 2

An anode substrate 16 was prepared by opening holes of diameter φ from 5 μm to 20 μm in a copper foil serving as a current collector (anode substrate 16) at a spacing of from 20 μm to 30 μm. The aperture ratio was about 10% per unit surface area. A typical method for opening holes is laser beam machining, however various means may be employed therefor such as punch pressing or the like using a needle stamp. Laser beam machining was employed in the Comparative Example 2. Note that a similar method to that of Comparative Example 1 was executed to produce the anode composite layer 18, and a negative electrode was obtained.

### Comparative Example 3

Laser beam machining was executed on the anode composite layer 18 of the negative electrode produced in Comparative Example 1 to form grooves 19. Although laser beam machining is a typical machining method employed, a method of masking during coating, and a method of cutting using a probe, or the like may be selected therefor. Machining was executed such that the groove width W1 was 500 μm and the spacing between adjacent grooves W2 and W3 were both 10 mm.

### Working Example

Laser beam machining was executed on the anode composite layer 18 of the negative electrode produced by the Comparative Example 2 to form the grooves 19. Machining was executed such that the groove width W1 was 500 μm and the spacing between adjacent grooves W2 and W3 were both 10 mm.

### Positive Electrode Fabrication

The positive electrode is an electrode including the cathode substrate 12 and the cathode composite layer 14.

A transition metal oxide of LiNi0.6Mn0.2Co0.2O2 was employed as the cathode active material. The cathode active material, a conductive auxiliary agent (acetylene black (AB), and a binder (polyvinylidene fluoride (PVdF)) were mixed together to achieve a ratio of 95:2.5:2.5 by weight %, N-methyl-2-pyrrolidone (NMP)) was added as a solvent, and particles therein were sufficiently distributed using a kneader to obtain a cathode paste. The cathode composite layer 14 was produced by coating the cathode paste onto an aluminum foil serving as a current collector (cathode substrate 12) using a doctor blade, and drying for 15 minutes or longer in an environment of 80° C. When doing so the post drying carried amount of the cathode composite layer 14 was adjusted so as to be 38 mg/cm². The produced positive electrode was subjected to biaxial roll pressing so as to obtain a positive electrode such that the density was 3.2 g/cc.

### Bipolar Electrode Configuration

A lithium ion battery that is an exemplary embodiment according to the present disclosure includes the bipolar electrodes 10 that each have a bipolar structure in which the cathode composite layer 14 and the anode composite layer 18 are arranged with the current collector 15 interposed therebetween. When configuring the bipolar structure, the positive electrode and the negative electrode may each be produced separately and then finally stuck together. Moreover, the current collector 15 (current collector foil) configured by the cathode substrate 12 (aluminum foil) and the anode substrate 16 (copper foil) stuck together, and a clad current collector foil or the like may be prepared in advance, and then the cathode composite layer 14 and the anode composite layer 18 may be produced by respectively coating these current collector foils. In the present working example, as an example, the bipolar electrode 10 is produced by respectively producing the positive electrode and the negative electrode, and then finally sticking these together.

### Lithium Ion Battery Fabrication

A lithium ion battery was produced using the bipolar electrodes 10 fabricated by the method described above. The bipolar electrodes 10 were superimposed on each other such that the cathode composite layer 14 and the anode composite layer 18 oppose each other, with the separators 13 interposed for electrical insulation between the bipolar electrodes 10. A film including polyethylene as a substrate was employed as the separator 13. The stack assembly produced thereby was wrapped in a lamination film, and after liquid injection of the electrolytic solution, sealed using a vacuum at −80 kPa. The electrolytic solution employed a carbonate based solvent of ethylene carbonate (EC), dimethyl carbonate (DMC), and ethylene methyl carbonate (EMC) mixed at EC:DMC:EMC=3:4:3 (ratio by volume) to dissolve a lithium salt of lithium hexafluorophosphate (LiPF6) (electrolyte) at 1.2 (g/mol).

### Evaluation Method

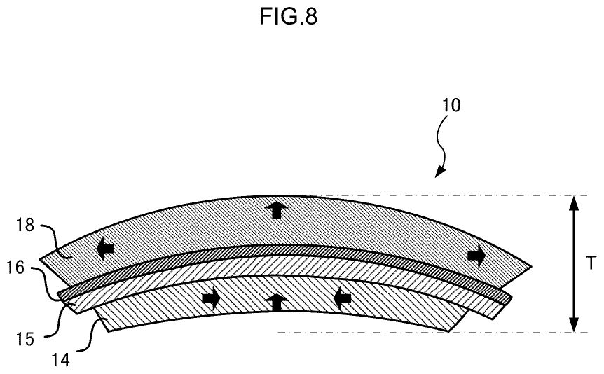

FIG. 8 is a schematic cross-section to explain a definition of warping (T). A charged lithium ion battery was disassembled and, as illustrated in FIG. 8, the bipolar electrode 10 was removed and left to stand on a horizontal plane, and a value of the height of a portion of the bipolar electrode 10 having the greatest thickness was measured as a definition of warping (T) magnitude.

Evaluation results of warping (T) are illustrated in Table 1.

TABLE 1

| | W1 | W2 | ANODE | | |
|---|---|---|---|---|---|
| | (μm) | (mm) | SUBSTRATE | T (WARPING) | |
| COMPARATIVE | | | NOT | 4 | NOT |
| EXAMPLE 1 | | | MACHINED | | ACCEPTABLE |
| COMPARATIVE | | | NOT | 3.2 | NOT |
| EXAMPLE 2 | | | MACHINED | | ACCEPTABLE |
| COMPARATIVE | 500 | 10 | MACHINED | 1.8 | NOT |
| EXAMPLE 3 | | | | | ACCEPTABLE |
| WORKING | 500 | 10 | MACHINED | 1 | ACCEPTABLE |
| EXAMPLE | | | | | |

As is apparent from Table 1, the working example, which satisfied the conditions of the grooves 19 being provided in the anode composite layer 18 and the elastic layer 20 being provided between the anode substrate 16 and the anode composite layer 18, was able to reduce warping compared to the Comparative Examples 1 to 3 not satisfying these conditions. It is accordingly apparent therefrom that the working example was able to suppress warping from developing during charging and discharging.

What is claimed is:

1. A bipolar electrode comprising:
a cathode substrate that configures a current collector;
a cathode composite layer formed on the cathode substrate;
an anode substrate that configures a current collector;
an anode composite layer that is formed on the anode substrate and that is divided into a plurality of regions by a groove between adjacent regions of the plurality of regions, with the anode substrate as a bottom portion of the groove; and
an elastic layer having elastic properties that is formed between the anode substrate and the anode composite layer,
wherein the cathode composite layer, the cathode substrate, the anode substrate, the elastic layer, and the anode composite layer are stacked in this sequence.

2. The bipolar electrode of claim 1, wherein the elastic layer has a tensile-shear adhesive strength of from 15 MPa to 40 MPa, a peel adhesive strength of from 3 N to 10 N, a modulus of elasticity of from 700 MPa to 1200 MPa, a breaking strength of from 15 MPa to 25 MPa, and an elongation percentage at breaking of from 5% to 30%.

3. The bipolar electrode of claim 1, wherein the elastic layer has an electron conductivity of 1 mS/cm.

4. The bipolar electrode of claim 1, wherein the elastic layer contains a conductive auxiliary agent and a polymer material.

5. The bipolar electrode of claim 1, wherein a thickness of the elastic layer is 10 μm or less.

6. The bipolar electrode of claim 1, wherein:
the anode composite layer has a rectangular shape as viewed from a stacking direction; and
a plurality of grooves are formed so as to respectively extend at the anode composite layer along directions substantially parallel to a short edge side and a long edge side of the anode composite layer as viewed from the stacking direction.

7. The bipolar electrode of claim 1, wherein:
the anode composite layer includes at least an anodic active material; and
the anodic active material contains silicon at a content of 10% or less.

8. The bipolar electrode of claim 1, wherein a groove width of the groove is from 50 μm to 5 mm.

9. The bipolar electrode of claim 1, wherein a spacing between adjacent grooves is from 1 mm to 100 mm.

10. The bipolar electrode of claim 1, wherein a proportion of a groove width of the groove with respect to a spacing between adjacent grooves is 0.05.

11. The bipolar electrode of claim 1, wherein an external profile dimension of the anode composite layer is at least 1000 mm.

12. The bipolar electrode of claim 1, wherein there are more grooves at a center region of the anode composite layer than at an outside region of the anode composite layer.

13. The bipolar electrode of claim 1, wherein grooves are provided uniformly at the anode composite layer.

14. The bipolar electrode of claim 1, wherein a groove is not provided at the cathode composite layer.

15. A bipolar battery comprising:
a plurality of bipolar electrodes of claim 1 stacked with a separator formed from an organic material interposed between adjacent bipolar electrodes of the plurality of bipolar electrodes; and
an electrolytic solution.
